(19) United States
(12) Patent Application Publication
(10) Pub. No.: US 2013/0304333 A1
(43) Pub. Date: Nov. 14, 2013

(54) METHOD FOR REDUCING A TRAFFIC JAM RISK

(71) Applicant: Thomas Fuehrer, Stuttgart-Weilimdorf (DE)

(72) Inventor: Thomas Fuehrer, Stuttgart-Weilimdorf (DE)

(73) Assignee: ROBERT BOSCH GMBH, Stuttgart (DE)

(21) Appl. No.: 13/888,477

(22) Filed: May 7, 2013

(30) Foreign Application Priority Data
May 11, 2012 (DE) 10 2012 207 864.9

(51) Int. Cl. G08G 1/0968

(52) U.S. Cl. CPC G08G 1/096811
USPC 701/51; 701/118

(57) ABSTRACT

A method for preparing a driving profile includes: recording a value of an operating characteristic of a motor vehicle by a sensor situated inside the motor vehicle; linking the value with location information indicating a position of the motor vehicle in order to obtain linked information; transmitting the linked information to a server; analyzing a plurality of linked items of information in order to detect a target location where a probability of the occurrence of a traffic jam lies above a threshold value; preparing route information by which travel in the target location is avoided; and transmitting the route information to a motor vehicle.

### BACKGROUND OF THE INVENTION

1. Field of the Invention

The present invention relates to a method for reducing a traffic jam risk.

2. Description of the Related Art

It is known to equip motor vehicles with radar systems. Such radar systems could be far- or medium-range radar systems, for example. The radar systems can be used to ascertain a distance between a motor vehicle and another motor vehicle driving ahead and/or following. Within the framework of a safety function, the distance determination may be used to detect a looming collision and to prevent it by outputting a warning to a vehicle driver and/or by rendering automatic brake assistance to the driver. As an alternative or in addition, the distance determination may also be used in a driver-assistance system developed to intervene in an engine management and/or a brake management of the motor vehicle, in order to control the speed and/or the distance.

It is likewise known to equip motor vehicles with navigation systems, which are set up to determine a current position of a motor vehicle. For example, the position can be determined with the aid of GPS signals.

### BRIEF SUMMARY OF THE INVENTION

A method for reducing a traffic jam risk according to the present invention includes steps for recording a value of an operating characteristic of a motor vehicle by a sensor situated inside the motor vehicle; for linking the value with location information that indicates a position of the motor vehicle, in order to obtain linked information; for transmitting the linked information to a server; for analyzing a plurality of linked items of information in order to detect a location at which a probability a traffic jam occurrence lies above a threshold value; for preparing route information by which travel in the location is avoided; and for transmitting the route information to a motor vehicle. This method advantageously allows the preparation of route information which, when taken into account, reduces a risk of getting caught in a traffic jam. Preparing the optimized route information advantageously requires only data that are determined anyway in a motor vehicle equipped with a sensor and with a device for determining a position. As a result, the method is advantageously able to be implemented at low expense. The motor vehicle to which the route information is transmitted may be the vehicle that transmits the linked information, or it may be some other motor vehicle. This advantageously allows high flexibility of the method.

In one preferred specific embodiment of the method, the plurality of linked items of information are analyzed in order to determine that the probability of the occurrence of a traffic jam at the location is higher than the threshold value within a regularly occurring time interval. The route information is prepared in such a way that travel in the location is avoided during the particular time interval. In this way the method advantageously makes it possible to detect regularly occurring traffic patterns and to take them into account when planning travel routes. It is therefore possible, for example, to avoid that a motor vehicle gets caught in a frequently occurring traffic jam during rush hour.

In one specific embodiment of the method, the route information is transmitted to a navigation system of the motor vehicle. This advantageously makes it possible for the navigation system of the motor vehicle to take the route information into account automatically.

In one further specific embodiment of the method, the route information includes delivery schedules. The delivery schedules may be a delivery schedule of an operator of a vehicle fleet. In that case it is advantageously possible to set up the routes to be covered by the motor vehicles of the vehicle fleet so that travel in locations is avoided at times when the occurrence of a traffic jam is to be expected.

In one further development of the method, the method includes additional steps for preparing a driving profile and for transmitting the driving profile to a driver-assistance system of the motor vehicle. The driving profile advantageously is able to be prepared in such a way that, if taken into account by the driver-assistance system of the motor vehicle, the motor vehicle will reach a traffic jam at a later point in time or even avoid it completely. This makes it possible for a traffic jam to dissolve faster or to possibly prevent it from occurring altogether.

In one useful development of the method, the operating characteristic is a speed or an acceleration or a braking deceleration of the motor vehicle, a distance between the motor vehicle and another motor vehicle driving ahead or trailing, or a selected gear stage of the motor vehicle. Using one or several of these operating characteristic(s), it is advantageously possible to detect in reliable manner whether the vehicle is stuck in a traffic jam.

In one further refinement of this method, it is determined that the probability of the occurrence of a traffic jam lies above the threshold value if a speed of the motor vehicle is below a specified limit and/or a distance between the motor vehicle and another motor vehicle traveling ahead or trailing behind lies below a specified limit. This advantageously utilizes the realization that motor vehicles stuck in traffic jams move at a low speed and maintain only small distances between each other.

In one preferred specific embodiment of the method, a plurality of motor vehicles transmits information to the server. The motor vehicles, for example, may be motor vehicles of a related vehicle fleet. In an advantageous manner, the server then receives information from different points of a route network simultaneously, which increases the accuracy of the analysis of the linked information by the server.

In one useful specific embodiment of the method, the sensor is a radar sensor. Radar sensors are advantageously suitable for determining distances between a motor vehicle and surrounding additional motor vehicles. In many cases the motor vehicles advantageously already come equipped with sensors of this type. This advantageously makes it possible to implement the method without major additional expense.

### BRIEF DESCRIPTION OF THE DRAWINGS

FIG. 1 shows a schematic block diagram of a motor vehicle and a server.

FIG. 2 shows a schematic flow chart of a method for reducing a traffic jam risk.

FIG. 3 shows a schematic illustration of linked information.

### DETAILED DESCRIPTION OF THE INVENTION

FIG. 1 shows a schematic illustration of a motor vehicle 100. Motor vehicle 100, for example, may be a passenger car. However, motor vehicle 100 may also be a delivery vehicle, a truck or some other motor vehicle. Motor vehicle 100 could be part of a fleet of related motor vehicles. For example, motor vehicle 100 may be part of a fleet of delivery vehicles of a freight-forwarding company or a parcel delivery service.

Motor vehicle 100 has a control unit 110. Control unit 110 preferably is realized as a combination of hardware and software components. For example, control unit 110 may include a microcontroller or a microcomputer on which a program is running. In addition, control unit 110 may include volatile and non-volatile data stores.

Motor vehicle 100 also includes at least one sensor 120. Sensor 120 may be used to determine a value of an operating characteristic of motor vehicle 100. The term “operating characteristic” within the context of this description denotes any quantity and any information that characterizes and quantifies an operating mode, an operating type or the operation of motor vehicle 100 in general.

The operating characteristic of motor vehicle 100, for example, may be a speed of motor vehicle 100. In this case sensor 120 is developed to determine a speed of the motor vehicle. The operating characteristic of motor vehicle 100 may also be an acceleration or a braking deceleration of the motor vehicle. In this case sensor 120 is developed to determine an acceleration or braking deceleration of motor vehicle 100. The operating characteristic of motor vehicle 100 may also be a selected gear stage of a transmission of the motor vehicle. In this case sensor 120 is developed to determine the selected gear stage of motor vehicle 100.

The operating characteristic of motor vehicle 100 may also be a distance between motor vehicle 100 and another vehicle driving ahead or another motor vehicle trailing motor vehicle 100. In this case sensor 120 is developed to determine such a distance. Sensor 120 preferably is developed as radar sensor in such a case, for instance as far- or medium-range radar sensor.

Sensor 120 may also be a video camera, a stereo video camera, a scanning lidar sensor (light detecting and ranging) or a scanning radar sensor. Sensors of this type are also suitable for analyzing an environment of motor vehicle 100 or for ascertaining distances between motor vehicle 100 and surrounding additional motor vehicles.

Motor vehicle 100 may also include a plurality of sensors 120. The plurality of sensors 120 then is preferably used to determine values of a plurality of different operating characteristics of motor vehicle 100. For example, motor vehicle 100 may include a first radar sensor for determining a distance between motor vehicle 100 and another vehicle driving ahead, a second radar sensor for determining a distance between motor vehicle 100 and another trailing vehicle, and a speed sensor for determining a speed of motor vehicle 100.

In the exemplary embodiment shown in FIG. 1, motor vehicle 100 also includes a driver-assistance system 130. The driver assistance system may also be referred to as adaptive cruise control (ACC). Driver-assistance system 130 may be used to realize an automatic speed and/or distance control of motor vehicle 100. Toward this end, driver-assistance system 130 may be developed to intervene in an engine management and/or a brake management of motor vehicle 100. In this case driver-assistance system 130 may also be developed to receive values, determined by sensor 120, of one or a plurality of operating characteristic(s) of motor vehicle 100. In particular, driver-assistance system 130 may be developed to receive distance values from a radar sensor. In a simplified embodiment of motor vehicle 100, however, driver-assistance system 130 may also be omitted.

In addition, motor vehicle 100 is equipped with a navigation system 140. Navigation system 140 is developed to ascertain a position of motor vehicle 100. For example, navigation system 140 is able to be developed to ascertain the position of motor vehicle 100 by receiving a GPS signal.

In addition, motor vehicle 100 is equipped with a display device 150. Display device 150 is used to display information to the driver of motor vehicle 100. For example, display device 150 may be developed as a screen or a small light. It is also possible that motor vehicle 100 is equipped with a plurality of display devices 150. Display device 150 may also be part of driver-assistance system 130 or of navigation system 140, or it may be used by driver-assistance system 130 and/or navigation system 140.

Control unit 110 of motor vehicle 100 is connected to sensor 120, driver-assistance system 130, navigation system 140 and display device 150. Via the connections, control unit 110 is able to exchange data and information with sensor 120, driver-assistance system 130, navigation system 140 and display device 150, and to actuate sensor 120, driver-assistance system 130, navigation system 140 and display device 150.

The schematic representation in FIG. 1 additionally shows a server 160. Server 160 is disposed outside of motor vehicle 100. For example, server 160 may be a computer in a computing center. It is also possible that server 160 is realized by a plurality of networked computers which are situated in one or in multiple computing center(s). Server 160 may be part of a cloud infrastructure or part of a service of a social network. If motor vehicle 100 is part of a vehicle fleet, server 160 in particular may be a server of an operator of the vehicle fleet.

Control unit 110 of motor vehicle 100 is developed to communicate with server 160 via a bidirectional communication link 170. Bidirectional communication link 170 preferably is a wireless communication link. For example, bidirectional communication link 170 may be developed as connection according to an Internet protocol via a mobile telephony network. Toward this end, control unit 110 then is connected to, or equipped with, suitable transmission and receiving units.

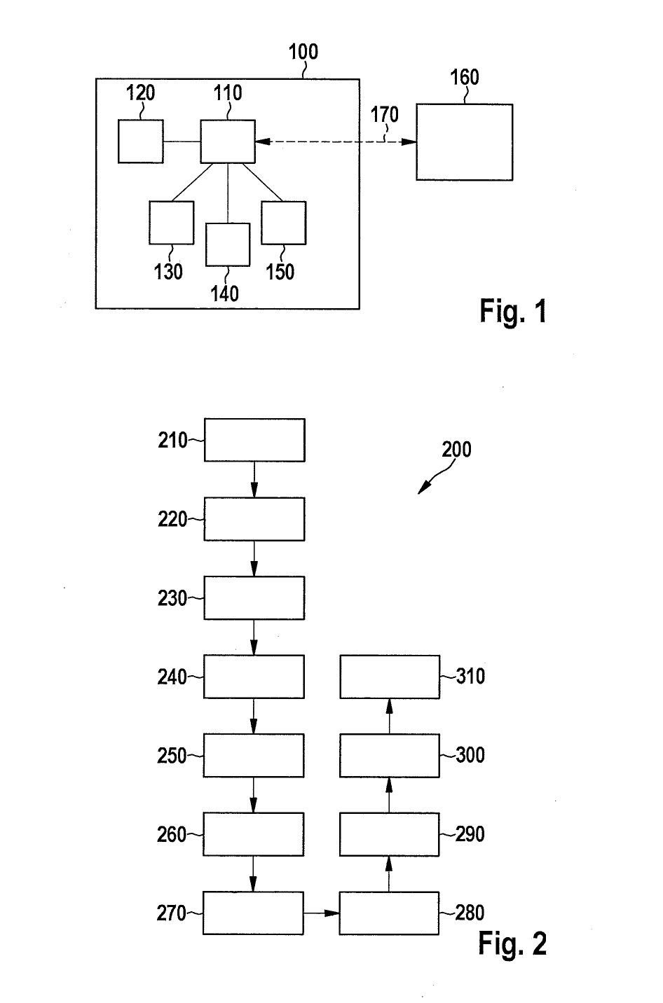

FIG. 2 illustrates a schematic flow chart of a method 200 for preparing a driving profile. Method 200 is partially executed by control unit 110 of motor vehicle 100 and partially by server 160, as will be explained in the following text.

In a first method step 210, control unit 110 ascertains a value of an operating characteristic of motor vehicle 100. To do so, control unit 110 receives a value determined by sensor 120. Control unit 110 may also receive a plurality of values determined by multiple sensors 120. For example, in first method step 210, control unit 110 may record a speed of motor vehicle 100, as well as a distance between motor vehicle 100 and another motor vehicle driving ahead of motor vehicle 100.

In a second method step 220, control unit 110 ascertains a position of motor vehicle 100. If possible, the position of motor vehicle 100 is ascertained simultaneously with the value of the operating characteristic of motor vehicle 100 recorded in first method step 210. Control unit 110 utilizes navigation system 140 to ascertain the position of motor vehicle 100. The determined position of motor vehicle 100 may also be referred to as location information.

In a third method step 230, control unit 110 links the value of the operating characteristic of motor vehicle 100 recorded in first method step 210, to the location information ascertained in second method step 220 in order to obtain linked information.

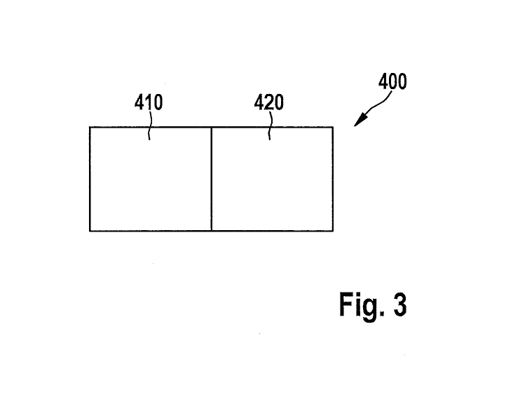

FIG. 3 shows a schematic illustration of linked information 400. Linked information 400 includes a value 410 of an operating characteristic of motor vehicle 100 determined in first method step 210, as well as location information 420 ascertained in second method step 220, which indicates a position of motor vehicle 100 at the instant at which value 410 of the operating characteristic is recorded.

In a fourth method step 240, control unit 110 transmits linked information 400 obtained in the third method step to server 160 via bidirectional communication link 170.

First method step 210, second method step 220, third method step 230, and fourth method step 240 preferably are repeated many times. Especially preferably, method steps 210, 220, 230, 240 are repeated on a continuous basis while motor vehicle 100 is being driven, such as once per second or once per minute, for example. In this way a multitude of location-dependent values 410 of one or a plurality of operating characteristic(s) of motor vehicle 100 is transmitted to server 160.

If motor vehicle 100 is part of a fleet of related motor vehicles, then all motor vehicles 100 of the vehicle fleet preferably execute method steps 210, 220, 230, 240 repeatedly.

In this way location-dependent values 410 of one or a plurality of operating characteristic(s) of multiple motor vehicles 100 having different drivers are transmitted to server 160.

In a fifth method step 250, server 160 analyzes the plurality of linked items of information 400 transmitted to server 160 so that a location at which a likelihood of an occurring traffic jam lies above a threshold value may be detected. In so doing, server 160 analyzes linked information 400 for the occurrence of distance and speed information that is typical of traffic jams. For example, motor vehicles caught in a traffic jam typically move at a low speed and maintain only small distances between each other. In traffic jams these characteristics usually occur over a longer period of time. The server is able to evaluate such characteristics in linked information 400 by probabilities of the existence of a traffic jam. If similar information is transmitted to the server 160 from a plurality of motor vehicles 100, then there is an increased likelihood that a traffic jam is at hand.

In one further development of the method, the server is also able to detect that a probability of a traffic jam occurrence at a particular location lies above a specified threshold value in a regularly recurring time interval. For example, server 160 could detect that motor vehicles which travel a particular route, such as a main traffic artery of a large city, at a particular time during rush hour happen to get caught in a traffic jam at regular intervals. In this case, server 160 thus is developed to detect not only the existence of a current traffic jam, but also to predict a probability of the occurrence of a future traffic jam.

In a sixth method step 260, server 160 prepares route information. The route information is prepared in such a way that travel in at least one location for which it was detected that the probability of a traffic jam occurrence lies above the threshold value is avoided. The route information may be prepared in such a way that the probable traffic jam is bypassed. It is also possible to prepare the route information such that travel in the location where a traffic jam most likely exists takes place only after the traffic jam has already broken up. If it is impossible to completely avoid travel in a location where a traffic jam most likely exists, then the route information is prepared in such a way that travel in the location is only of short duration and/or on the shortest possible route section.

In a seventh method step 270, the route information prepared in sixth method step 260 is transmitted to a motor vehicle 100. The transmission preferably takes place via bidirectional communication link 170.

Motor vehicle 100 receiving the route information may be a motor vehicle 100 that has transmitted one or a plurality of linked items of information 400 to server 160. However, motor vehicle 100 receiving the route information may also be a second motor vehicle 100 that trails a first motor vehicle 100 which has transmitted to server 160 one or a plurality of linked item(s) of information 400, from which information about the existence of a traffic jam is able to be derived. In this case, second motor vehicle 100 receives route information which enables it to avoid travel in the location at which first motor vehicle 100 was caught in a traffic jam.

The route information prepared in sixth method step 260 and transmitted to motor vehicle 100 in seventh method step 270 may be route information for navigation system 140 of motor vehicle 100. In this case, the route information is preferably transmitted directly to navigation system 140 and taken into account by navigation system 140 in an eighth method step 280. Navigation system 140 then is able to display the route information via display device 150, for example.

However, the route information prepared in sixth method step 260 and transmitted in seventh method step 270 may also be a delivery schedule of an operator of a vehicle fleet. If a location was detected in fifth method step 250 at which the probability of the occurrence of a traffic jam lies above the threshold value in a regularly recurring time interval, then the delivery schedule may be prepared in such a way, for example, that travel in this location during this time interval is avoided by all motor vehicles 100 of the vehicle fleet. For example, it is possible to select a delivery sequence in such a way that travel in the location is not required during said time interval.

In one further development of method 200, a driving profile for driver-assistance system 130 may be prepared in addition in a ninth method step 290, and this driving profile is able to be transmitted to driver-assistance system 130 in a tenth method step 300. Driver-assistance system 130 then controls motor vehicle 100 according to the driving profile in an eleventh method step 310.

The driver profile may include maximum speeds, ideal speeds, preferred distances of motor vehicle 100 from surrounding motor vehicles and/or preferred acceleration and braking values. If a location was detected in fifth method step 250 at which a likelihood of the occurrence of a traffic jam lies above the threshold value, and if travel in this location is unavoidable, then the driving profile may be prepared in ninth method step 290 in such a way that the location is reached at a later point in time. This means that less time needs to be spent in the traffic jam before it dissolves. It is also possible to prepare the driving profile in ninth method step 290 in such a way that the probability of the occurrence of a traffic jam is reduced by careful driving of motor vehicle 100 (or preferably multiple motor vehicles 100 of a vehicle fleet).

In one general specific embodiment, method 200 is used for utilizing sensors 20, which are installed in motor vehicle 100 as it is, for the purpose of collecting driver behaviors and driving profiles of individual drivers of a fleet of motor vehicles 100. Such information, for example, includes speed, distance, acceleration and braking information, and possibly additional information such as a gear stage of a transmission. The profiles of individual drivers are linked (tagged) with a route already traveled and stored in a map. All of this information is centrally collected via server 160, such as services of a data cloud or a social network, e.g., of the fleet operator or its service provider. The collected data then are able to be analyzed according to distance and speed information that is typical of traffic jams (e.g., crawl speed and short distances, possibly only a few centimeters, over longer periods of time). If the same information is reported to server 160 from a plurality of fleet drivers, then the likelihood of a traffic jam rises. Method 200 begins with the optimization of the routes for the other fleet vehicles that have to travel along the route in its entirety or even only partially (e.g., known via active navigation or delivery scheduling of the day per driver/vehicle). The goal is to circumvent the traffic jam or to be affected by it only briefly. The method makes it possible to transmit this route information to the drivers of the fleet. The display takes place via display device 150 and/or navigation system 140.

Furthermore, method 200 also allows the transmission of a new ACC profile (maximum speeds, ideal speeds, distances, acceleration and braking information) to other fleet vehicles for preventive traffic jam avoidance or even minimization. The vehicles will reach the traffic jam at a later time and in this way possibly aid in dissolving it more rapidly.

What is claimed is:

1. A method for reducing the probability of encountering a traffic jam risk for a host vehicle, comprising:
a) recording a value of an operating characteristic of the host vehicle with the aid of a sensor situated inside the host vehicle;
b) linking the recorded value to location information indicating a position of the host vehicle to obtain a linked information item;
c) transmitting the linked information item to a server;
d) repeating steps a) through c) at least once;
e) analyzing the linked information items to detect a problem location at which a probability of an occurrence of a traffic jam lies above a predetermined threshold value;
f) calculating a route information which avoids the problem location; and
g) transmitting the calculated route information to the host vehicle.

2. The method as recited in claim 1, wherein the linked information items are analyzed to detect the probability of an occurrence of a traffic jam at the problem location lies above the predetermined threshold value in a regularly recurring time interval, and wherein the route information is calculated in such a way that travel through the problem location within the time interval is avoided.

3. The method as recited in claim 2, wherein the route information is transmitted to a navigation system of the host vehicle.

4. The method as recited in claim 3, wherein the route information includes a delivery schedule.

5. The method as recited in claim 3, further comprising:
preparing a driving profile;
transmitting the driving profile to a driver-assistance system of the motor vehicle.

6. The method as recited in claim 2, wherein the operating characteristic is at least one of: a speed of the host vehicle; an acceleration of the host vehicle; a braking deceleration of the host vehicle; a distance between the host vehicle and a second vehicle driving one of ahead or behind; and a selected gear stage of the host vehicle.

7. The method as recited in claim 6, wherein the probability of an occurrence of a traffic jam is determined to lie above the predefined threshold value if at least one of: a speed of the host vehicle is below a specified threshold speed; and a distance between the host vehicle and the second vehicle driving one of ahead or behind lies below a specified threshold distance.

8. The method as recited in claim 2, wherein multiple vehicles transmit linked information items to the server.

9. The method as recited in claim 2, wherein the sensor is a radar sensor.
